(19) United States
(12) Patent Application Publication
(10) Pub. No.: US 2020/0219169 A1
(43) Pub. Date: Jul. 9, 2020

(54) METHOD AND APPARATUS FOR PROVIDING A UNIFIED CLOUD-BASED PLATFORM FOR COMMERCIAL TRANSACTIONS AND ANALYSIS

(71) Applicant: Menus Enterprise, LLC, Los Angeles, CA (US)

(72) Inventor: Hooman S. Lahijani, Los Angeles, CA (US)

(21) Appl. No.: 16/146,486

(22) Filed: Sep. 28, 2018

Related U.S. Application Data
(60) Provisional application No. 62/565,781, filed on Sep. 29, 2017.

(51) Int. Cl. G06Q 30/06; G06Q 20/10; G06Q 30/02; G06Q 50/14; G06Q 20/32; G06Q 20/20; G06F 16/9535; G06N 20/00

(52) U.S. Cl. CPC G06Q 30/0633; G06Q 20/108; G06Q 30/0611; G06Q 30/0205; G06Q 30/0631; G06N 20/00; G06Q 20/3224; G06Q 20/202; G06Q 30/0201; G06F 16/9535; G06Q 50/14

(57) ABSTRACT

A process, operated by a smart phone connected to a cloud networking, facilitates web-based e-commerce transactions between users. The process is able to initiate a transaction by clicking one of multiple transactional selections managed by a mobile application (“app”) displayed on a screen of a smart phone. In one aspect, the cloud networking provides an option or recommendation to the user based on user's browsing pattern and categorization codes stored in the storage. After sending a packet representing the transaction together with a phone number associated to the smart phone to an app server, a user account associated with the smart phone is identified based on the phone number. Upon generating an order in response to the packet and retrieved information from the user account, the order is placed from the app server to an ordering system associated to a registered vendor for facilitating the transaction.

### PRIORITY

This application claims the benefit of priority based upon U.S. Provisional Patent Application having an application Ser. No. 62/565,781, filed on Sep. 29, 2017, and having a title of “Unified Cloud Base Ordering and Menu Analytic Platform,” which is hereby incorporated by reference in its entirety.

### FIELD

The exemplary embodiment(s) of the present invention relates to the field of communication networks. More specifically, the exemplary embodiment(s) of the present invention relates to e-commerce via big data and cloud-based networking.

### BACKGROUND

With increasing popularity of automation, online shopping, and intelligent electronic devices, such as computerized machines, IoT (the Internet of Things), smart vehicles, smart phones, drones, mobile devices, airplanes, artificial intelligence (“AI”), the demand of intelligent machine and faster real-time response are increasing. For machine learning to become mainstream, a significant number of pieces, such as data management, model training, machine learning, and data collection need to be constantly improved.

One popular online shopping or e-commerce is food related transactions. A problem, however, associated with the conventional way of online food ordering and/or delivery is that it is segmented and one vendor at a given time. The e-commence shop also takes time to login restaurant website or uses their proprietary applications (“Apps”). In addition, making online payment is often problematic and time consuming. For example, when it comes to placing an order over the phone, time can be wasted between the customer stating his location and payment information and restaurant operator inputting and verifying this information. What is more alarming is that in most cases the credit card information is that the information passed over the phone may be written down or recorded on a loose paper which creates security risk.

### SUMMARY

A process, which is operated by a smart phone connected to a cloud networking, is capable of facilitating web-based e-commerce transactions between two remote users. The process is able to initiate a transaction by clicking one of multiple transactional selections managed by a mobile application (“app”) displayed on a screen of a smart phone. In one aspect, the cloud networking provides an option or recommendation to the user based on user's browsing pattern and categorization codes stored in the storage. After sending a packet representing the transaction together with a phone number associated to the smart phone from the smart phone to an app server via a first communication network, a user account associated with the smart phone is identified based on the phone number. Upon generating an order in response to the packet and retrieved information from the user account, the order is placed from the app server to an ordering system associated to a registered vendor via a second communication network for facilitating the transaction.

For example, a network system capable of facilitating food distribution as such a restaurant includes a menus module, a group of customer web user interfaces (“UIs”), a group of customer mobile applications (“APPs”), and a group of distributors or vendors. The menus module is configured to provide procedures in creating general rules and dish code based on user geographic locations, preferences, and selections. The customer web UIs facilitates web-based user communication and the customer mobile Apps facilitate mobile based user communication. The distributors are configured to facilitate communication between the menus module and the distributors.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a unified cloud-based computing (“UCC”) platform capable of facilitating commercial transactions via mobile devices in accordance with one embodiment of the present invention;

FIG. 2 is a block diagram illustrating a food related e-commerce or transaction using the UCC platform via an identity of smart phone in accordance with one embodiment of the present invention;

FIG. 3 is a block diagram illustrating an MCS or MIMA system for a restaurant transaction using the UCC platform via a smart phone in accordance with one embodiment of the present invention;

FIG. 4 is a block diagram illustrating a user or customer module in MIMA system capable of handling user or customer related information in accordance with one embodiment of the present invention;

FIG. 5 is a block diagram illustrating a vendor or restaurant module in MIMA system capable of handling vendor or restaurant related information in accordance with one embodiment of the present invention;

FIG. 6 is a block diagram illustrating a MIMA system coupled to the UCC platform using application programming interfaces (“APIs”) in accordance with one embodiment of the present invention;

FIG. 7 is a logic flow diagram illustrating a process of menus information flow capable of facilitating food categorization and distribution in accordance with one embodiment of the present invention;

FIG. 8 is a data flow diagram illustrating a logical process of MIMA system used in a restaurant application for providing food ordering and delivery services in accordance with one embodiment of the present invention;

FIG. 9 is a block diagram illustrating functional modules used by MIMA system in accordance with one embodiment of the present invention;

FIG. 10 is a block diagram illustrating additional modules used by MIMA system in accordance with one embodiment of the present invention;

FIG. 11 is a logic block diagram illustrating an ordering and delivery process facilitated by Menus within the MIMA system in accordance with one embodiment of the present invention;

FIGS. 12A-12C are a set of flow diagrams illustrating a process of restaurant registration and verification operated by the MIMA system in accordance with one embodiment of the present invention;

FIG. 13 is a block diagram illustrating a payment process facilitated by the MIMA system in accordance with one embodiment of the present invention;

FIG. 14 is a logic flow diagram illustrating a process of providing recommendations or alternatives facilitated by the MIMA system in accordance with one embodiment of the present invention;

FIG. 15 is a flow chart illustrating a process of facilitating a real-time commercial transaction in accordance with one embodiment of the present invention;

FIG. 16 is a diagram illustrating a computer network capable of facilitating UCC platform in accordance with one embodiment of the present invention; and

FIG. 17 is a block diagram illustrating a digital processing system capable of being used and/or implementing the MIMA system and/or various modules for food distribution in accordance with one embodiment of the present invention.

### DETAILED DESCRIPTION

Embodiments of the present invention are described herein with context of a method and/or apparatus for facilitating e-commerce using a unified cloud-based computing (“UCC”) platform.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

A process, which is operated by a smart phone connected to a cloud networking, is capable of facilitating web-based e-commerce transactions between two remote users. The process is able to initiate a transaction by clicking one of multiple transactional selections managed by a mobile application (“app”) displayed on a screen of a smart phone. In one aspect, the cloud networking provides an option or recommendation to the user based on user's browsing pattern and categorization codes stored in the storage. After sending a packet representing the transaction together with a phone number associated to the smart phone from the smart phone to an app server via a first communication network, a user account associated with the smart phone is identified based on the phone number. Upon generating an order in response to the packet and retrieved information from the user account, the order is placed from the app server to an ordering system associated to a registered vendor via a second communication network for facilitating the transaction.

In one aspect, a network system capable of facilitating food distribution using cloud networking includes a menus module, a group of customer web user interfaces (“UIs”), a group of customer mobile applications (“APPs”), and a group of distributors such as restaurants. The menus module is configured to provide procedures in creating general rules and dish code based on user geographic locations, preferences, and selections. The customer web UIs facilitates web-based user communication and the customer mobile Apps facilitate mobile based user communication. The distributors are configured to facilitate communication between the menus module and the distributors.

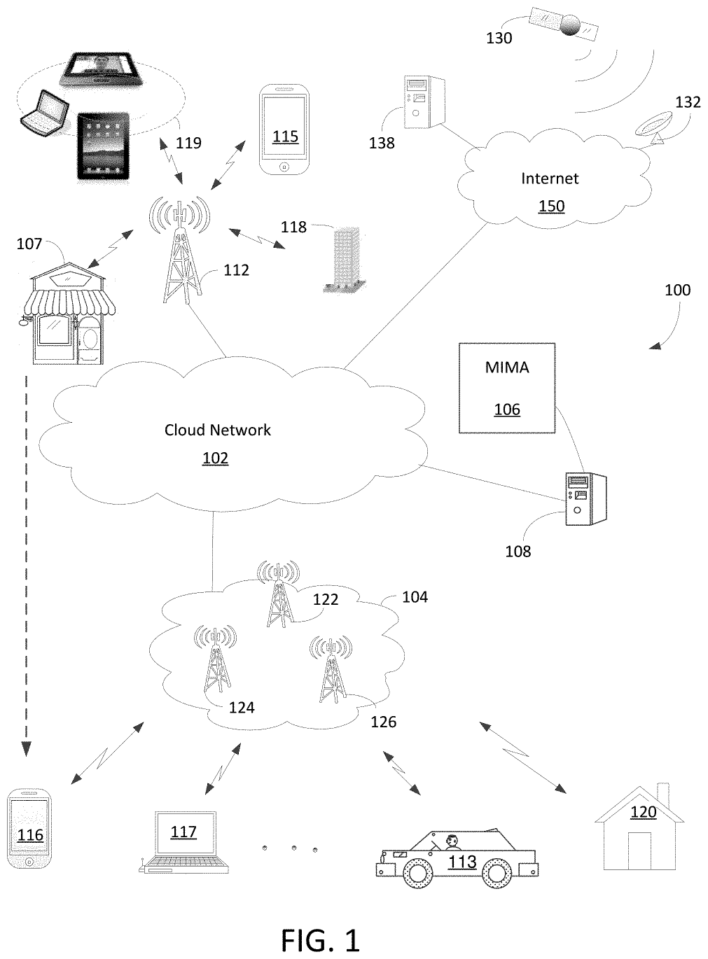

FIG. 1 is a block diagram illustrating a unified cloud-based computing (“UCC”) platform capable of facilitating food related e-commerce or transactions via mobile devices in accordance with one embodiment of the present invention. Diagram 100 illustrates MIMA 106, communication network 102, switching network 104, Internet 150, and portable electric devices 113-119. Network or cloud network 102 can be wide area network (“WAN”), metropolitan area network (“MAN”), local area network (“LAN”), satellite/terrestrial network, or a combination of WAN, MAN, and LAN. It should be noted that the underlying concept of the exemplary embodiment(s) of the present invention would not change if one or more blocks (or networks) were added to or removed from diagram 100.

Network 102 includes multiple network nodes, not shown in FIG. 1, wherein each node may include mobility management entity (“MME”), radio network controller (“RNC”), serving gateway (“S-GW”), packet data network gateway (“P-GW”), or HomeAgent to provide various network functions. Network 102 is coupled to Internet 150, UCC server 108, base station 112, and switching network 104. Server 108, in one embodiment, is a dedicated network machine capable of providing MIMA and/or MIMA management. MIMA can be software, hardware, or combination of software and hardware component. A function of MIMA is to provide commercial transaction such as food ordering and delivery using a smart phone with a phone number.

Switching network 104, which can be referred to as packet core network, includes cell sites 122-126 capable of providing radio access communication, such as 3G (3^{rd} generation), 4G, or 5G cellular networks. Switching network 104, in one example, includes IP and/or Multiprotocol Label Switching (“MPLS”) based network capable of operating at a layer of Open Systems Interconnection Basic Reference Model (“OSI model”) for information transfer between clients and network servers. In one embodiment, switching network 104 is logically coupling multiple users and/or mobiles 116-120 across a geographic area via cellular and/or wireless networks. It should be noted that the geographic area may refer to a campus, city, metropolitan area, country, continent, or the like.

Base station 112, also known as cell site, node B, or eNodeB, includes a radio tower capable of coupling to various user equipments (“UEs”) and/or electrical user equipments (“EUEs”). The term UEs and EUEs are referring to the similar portable devices and they can be used interchangeably. For example, UEs or PEDs can be cellular phone 115, laptop computer 117, iPhone® 116, tablets and/or iPad® 119 via wireless communications. Handheld device 116 can also be a smartphone, such as iPhone®, BlackBerry®, Android®, and so on. Base station 112, in one example, facilitates network communication between mobile devices such as portable handheld device 113-119 via wired and wireless communications networks. It should be noted that base station 112 may include additional radio towers as well as other land switching circuitry.

Internet 150 is a computing network using Transmission Control Protocol/Internet Protocol (“TCP/IP”) to provide linkage between geographically separated devices for communication. Internet 150, in one example, couples to supplier server 138 and satellite network 130 via satellite receiver 132. Satellite network 130, in one example, can provide many functions as wireless communication as well as global positioning system (“GPS”). For example, menu information management administration (“MIMA”) 106 can communicate with various smartphones 113-119 via satellite network 130, Internet 150, network 102, and/or switching network 104.

MIMA 106, which can be software, firmware, hardware, or a combination of software, hardware, and firmware, facilitates online commercial transaction(s) using smart phones with their phone numbers as partial authentication. For example, after a customer is registered with MIMA, the customer can order a dish or food with one click on its smart phone which will initiate an automatic ordering process authenticated by the phone number and placing the order directly to the point of sale (“POS”) terminal or system at the restaurant.

An advantage of employing MIMA is to facilitate a food related e-commerce for easier food ordering and delivery. In addition, MIMA can also generate transactional or e-commerce reports to subscribers for up-to-date marketing report.

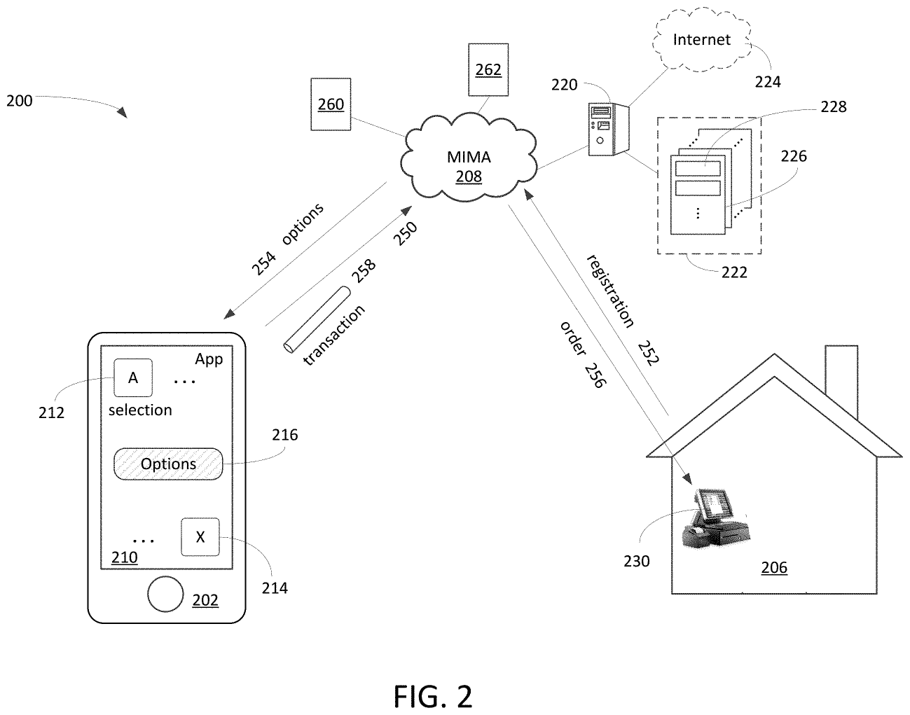

FIG. 2 is a block diagram 200 illustrating a food related e-commerce or transaction using the UCC platform via an identity of smart phone in accordance with one embodiment of the present invention. Diagram 200, in one aspect, includes a smart phone 202, vendor 206, and MIMA cloud server (“MCS”) 208. In one example, vendor 206 is a restaurant capable of preparing and delivering food. It should be noted that the underlying concept of the exemplary embodiment(s) of the present invention would not change if one or more blocks (or networks) were added to or removed from diagram 200.

MCS 208, in one embodiment, includes MIMA server 220 which includes database 222 containing customer and vendor information. Server 220 can further couple to other devices and/or networks such as Internet 224. MCS 208, in one example, can be a hardware system(s), software, firmware, and/or a combination of hardware, firmware, and/or software. Alternatively, MCS 208 can be a cluster of computers and/or servers situated across a communication network. MCS 208 can include other functions and/or modules 260-262 for generating reports as well as categorizing online menus.

A function of MCS 208 is to provide food selections within a geographic area to registered users based on extracted and categorized menus selections through a mobile App. In one embodiment, MCS 208 includes a menu generator containing a menu monitor and a menu processing device wherein menu monitor is responsible to capture relevant online menus while the menu processing device processes captured menus for categorization. Once the menus are identified and categorized, the processed data, also known as food selections are stored in a local storage such as database 222.

After obtaining location information and user, a set of food selections, for example, is pushed or transmitted from MCS 208 to display 210 of smart phone 202. MCS 208 is capable of generating a customer's order based on received transaction order such as transaction 258 and customer information via connection 250. The order is subsequently placed directly to an POS system such as point of sale (“POS”) 230 at restaurant 206 via connection 252. In one aspect, MCS 208 is also capable of providing alternatives or options to the user before or during the transaction is initiated. For example, the alternatives or options can be optional restaurants, dishes, prices, delivery time, and the like.

Database 222 stores user information 226 and vendor information wherein user information 226 includes user's or customer's information 228, such as, but not limited to, customer name, phone number, phone type, registration data, food preferences, payment methods, and the like. The vendor information includes vendor's name, merchandise, point of sale (“POS”) system, registration data, prices, and the like. In one example, the vendor can be a restaurant. Alternatively, the vendor can be a travel agency. In one embodiment, database 22 also includes a menu database which can be continuously updated in real-time or substantially real-time. Database 222, in one aspect, includes menu database containing food selections.

Smart phone 202, in one aspect, can be an iPhone containing a screen 210 capable of displaying icons or tiles 212-214 wherein each icon represents a food selection. During the process of selecting and ordering food, MCS 208, in one example, can provide option(s) or alternative selections 216 based on user's browsing activities, patterns, as well as vendor's promotion. For example, a user is browsing a list of coffee selections within a geographic area, a coffee shop could advertise its coffee with promotions interactively to the user via MCS 208. Smart phone 202 is coupled to one or more vendors such as vendor 206 via communication channels 250-256.

Vendor 206 can be a restaurant, retailer shop, financial service, travel agency, and the like. To provide goods or services through MCS 208, vendor 206 is required to register with MCS 208. A benefit of registering with MCS 208 is that vendor 206 can receive orders automatically without providing details and/or logistics of online ordering and/or delivery services. In one aspect, MCS 208 can automatically capture vendor's posted online menu and arrange third party delivery system(s) to handling food delivery.

The UCC platform containing MCS 208 for facilitating web-based commercial transactions between customers and vendors includes a group of vendors such as vendors 206, portable devices used by users such as smart phones 202, and MIMA module such as MCS 208. In one embodiment, the vendors are registered with the UCC platform for offering goods and services in accordance with their online menus posted via their own websites. The users or customers are registered with the UCC platform and able to view various menus and advertisements on their smart phones via the UCC App. The MIMA module which is coupled to the UCC platform is configured to continuously update MIMA vendor database (“DB”) such as DB 222 via an online self-learning or machine learning monitoring device. The MIMA module, in one aspect, is able to provide an alternative option based on information stored in MIMA DB when a customer is in a process of placing an order. The MIMA module, in one example, is able to generate a real-time market competitive report to a restaurant subscriber or a government agency.

An advantage of employing MCS 208 is that it is able to selectively provide merchandise, services, and/or food to various users via their smart phones for facilitating e-commerce using captured and processed online information.

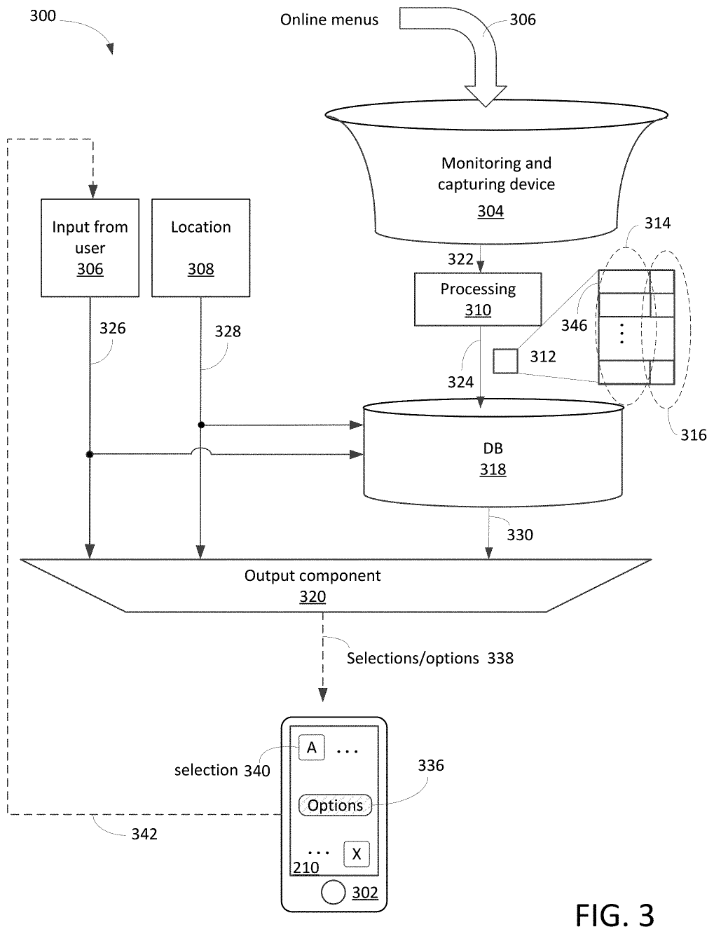

FIG. 3 is a logic block diagram 300 illustrating an MCS or MIMA system for a restaurant transaction using the UCC platform via a smart phone in accordance with one embodiment of the present invention. Diagram 300 includes a monitoring and capturing device (“MCD”) 304, DB 318, processing device 310, and smart phone 302. In one aspect, smart phone 302 is coupled to MIMA system via a wireless network connection as indicated by numerals 342 and 338. It should be noted that the underlying concept of the exemplary embodiment(s) of the present invention would not change if one or more blocks (or networks) were added to or removed from diagram 300.

MCD 304, in one embodiment, is configured to continuously monitor new online menus over the network based on one or more geographic locations. For example, MCD 304 scans restaurant online menus to determine whether such menu(s) is new or existing one which is already in DB 318. When MCD 304 determines that a menu is new, the new menus such as indicated by numeral 306 is captured. After capturing, the new menu is forwarded to processing device 310 via connection 322.

Processing device 310, in one embodiment, parses the new menu into multiple headings, such as breakfast, lunch, and dinner. Based on the headings, the menu items (“MIs”) are further separated and categorized. In one aspect, a self-learning or machine learning module is used to identify the nature of the food. For example, omelet is a type of food or MI under the heading of breakfast. Processing device 310 is further configured to determine the dish type based on the learned MI. For example, dish type being omelet under breakfast can be categorized as egg with cheese under MI. After processing, a searchable table or searchable menu 312 containing MI 314 and dish type 316 is forwarded from processing device 310 to DB 318 via connection 324.

DB 318, in one embodiment, stores searchable tables such as table 312 containing multiple entries 346 wherein each entry contains at least one menu item (“MI”) 314 and one dish type 316. DB 318 is further configured to store information relating to vendors as well as customers. For example, the registration information for both customers and vendors are stored in DB 318. It should be noted that the terms “customer”, “user”, and “buyer” can be referred to the same party and they can be used interchangeably. Also, the terms “vendor”, “restaurant”, “agent”, and “shop” can be referred to the same party and they can be used interchangeably.

Output or selection output component 320, in one aspect, receives user information from user input module 306 and GPS (global positioning system) locator 308. Based on the user information, output component 320 is able to generate a selection or selections and sends the selections to smart phone 302 for display as indicated by numeral 340. Alternatively, output component 320 is also capable of providing options 338 to smart phone 302 for display as indicated by numeral 336.

User input module 306 and locator 308 are configured to provide user related information. For example, module 306 is capable of capturing what user is currently browsing. Locator 308, in one embodiment, uses GPS to locate current location of user whereby a delivery could be achieved based on the location of user. It should be noted that user information and user current location are also forwarded to DB 318 whereby a proper option(s) can be identified based on the location(s).

Smart phone 302, in one embodiment, is a portable system capable of continuously communicating with MIMA system so that MIMA system can push selections and options to user(s) by displaying the selection(s) on users' smart phones. When a user clicks or pushes one icon as the selection, a food ordering transaction is immediately transmitted to the MIMA system. The MIMA system will place the order directly to the POS at the vendor. If the vendor does not have the capability to deliver the food or goods, the MIMA system will make arrangement to have a carrier to deliver the food or goods based on user's stored preference as well as specific instruction.

An advantage of organizing DB 318 with MI and dish type is that it allows the system to search the DB more efficiently.

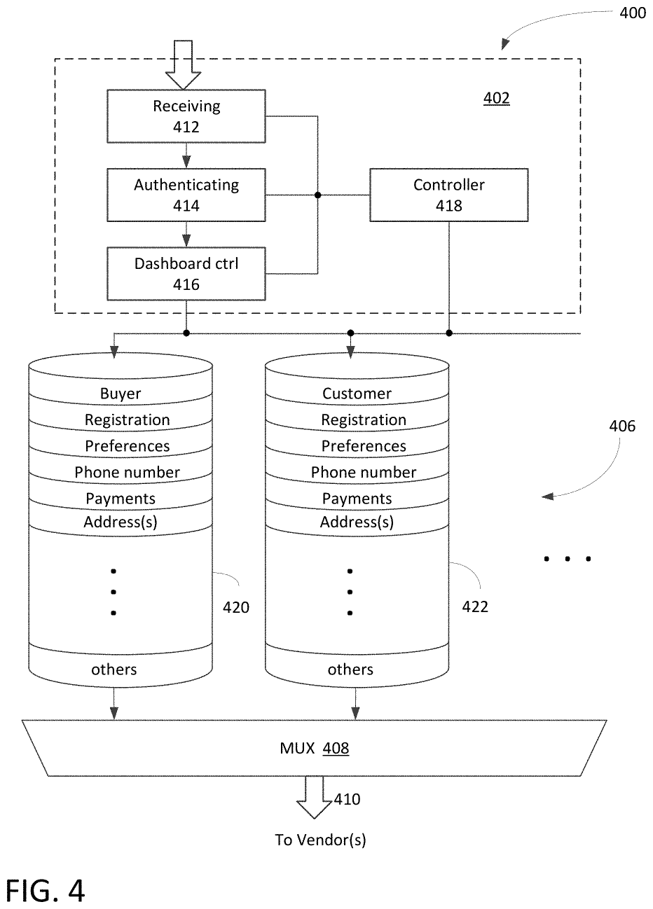

FIG. 4 is a logic block diagram 400 illustrating a user or customer module in MIMA system capable of handling user or customer related information in accordance with one embodiment of the present invention. Diagram 400 includes a user module 402, user database 406, and multiplexer (“Mux”) 408. In one aspect, user module 402 includes a receiving unit 412, authenticating unit 414, dashboard controller 416, and controller 418 wherein controller 418 is configured to manage and coordinate receiving unit 412, authenticating unit 414, and dashboard controller 416. It should be noted that the underlying concept of the exemplary embodiment(s) of the present invention would not change if one or more blocks (or networks) were added to or removed from diagram 400.

Database 406 includes multiple storage containers or sections 420-422 for storing different users' information. For example, container 420 stores information relating to a user who may be a buyer purchasing merchandise and/or services via the UCC App. Container 420 includes buyer's name, registration information, preferences, phone number(s), preferred payment methods, address, and the like. Container 422, on the other hand, can store information relating to a customer who regularly orders food or meals via the UCC App. Container 422 may include customer's name, registration information, preferences, phone number(s), preferred payment methods, address, and the like.

User module 402 which, in one aspect, can be a part of MIMA system, is configured to store information from users and post or push information or selections to users' equipment (“UE”). For example, upon receiving data or input information from user or UE, receiving unit 412 forwards received information to authenticating unit 414. After authenticating and/or verifying, the authenticated information is transmitted to dashboard controller 416 for posting. Dashboard controller 416, in one embodiment, uses Mux 408 to post or push selections as well as options as indicated by numeral 410 to the UE interactively. For example, if user is looking at various pizza parlors, dashboard controller 416 is able to push pizza restaurants in the vicinity to the user onto user's UE screen including options and/or promotions.

An advantage of using MIMA DB with categorization is that the DB is able to produce or output searchable results so that a price or quality comparison between similar dish becomes possible. For instance, before a user places his/her order, MIMA is able to suggest or recommend an alternative restaurant which provides similar dish with lower price.

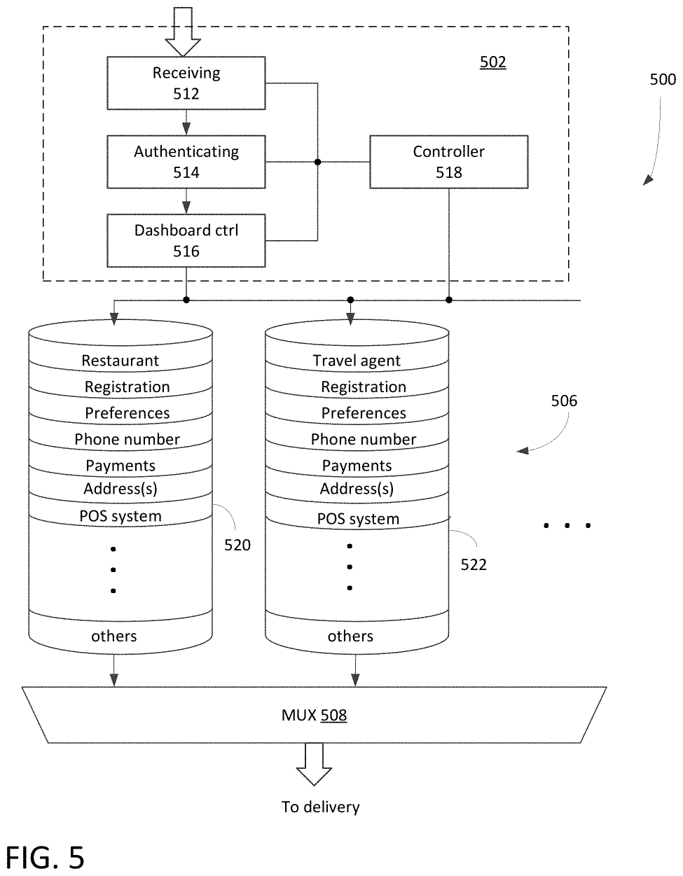

FIG. 5 is a block diagram 500 illustrating a vendor or restaurant module in the MIMA system capable of handling vendor or restaurant related information and e-commerce in accordance with one embodiment of the present invention. Diagram 500 includes a vendor module 502, vendor database 506, and multiplexer (“Mux”) 508. In one aspect, vendor module 502 includes a receiving unit 512, authenticating unit 514, dashboard controller 516, and controller 518 wherein controller 518 manages and/or coordinates units 512-516. It should be noted that the underlying concept of the exemplary embodiment(s) of the present invention would not change if one or more blocks (or networks) were added to or removed from diagram 500.

Database 506 includes multiple storage sections 520-522 containing different vendor information. For example, container 520 stores information relating to a restaurant that offers food. Container 520 includes restaurant's name, registration information, preferences, phone number(s), preferred payment methods, delivery, POS, address, and the like. Container 522, on the other hand, can store information relating to a travel agent who provides travel plans using the MIMA system. Container 522 may include agent's name, registration information, preferences, phone number(s), preferred payment methods, address, POS system, and the like.

Vendor module 502 which is a part of MIMA system is configured to store information from vendors. A function of vendor module 502 is to register vendors and fulfill orders and/or transactions based on orders placed by various users via their UEs. For example, upon receiving an order as the input information from user or UE, receiving unit 512 forwards received order (or registration information) to authenticating unit 514. After authentication, the order is transmitted to dashboard controller 516 for order or transaction fulfillment. Dashboard controller 516, in one embodiment, uses Mux 508 to fulfill the order. For example, if the vendor is a pizza parlor, dashboard controller 516 will inform the pizza parlor to make the ordered pizza and subsequently deliver the pizza to the ordered customer. In the event that the restaurant does not offer delivery, a third-party delivery company will be arranged by the MIMA system for the food delivery.

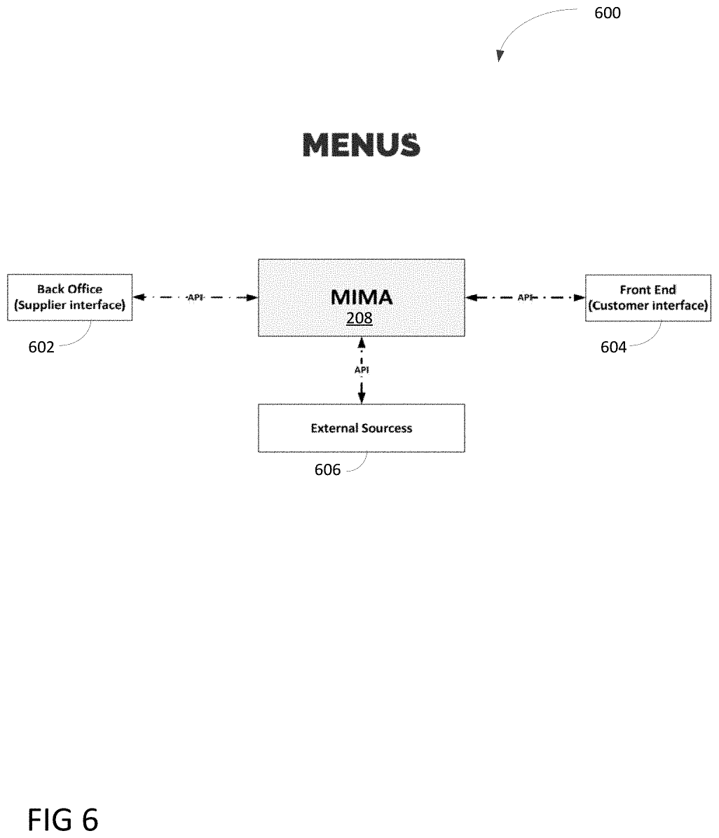

FIG. 6 is a block diagram 600 illustrating a MIMA system coupled to the UCC platform using application programming interfaces (“APIs”) in accordance with one embodiment of the present invention. Diagram 600 illustrates a MENUS process operable under the MIMA system capable of providing a software platform which facilitates a process of supplying, ordering, and delivery of goods (between suppliers and customers) using mobile/web base applications. Menus or MENUS, in one aspect, can be a system similar to the MIMA system under the UCC platform. Alternatively, Menus includes the MIMA system. It should be noted that the underlying concept of the exemplary embodiment(s) of the present invention would not change if one or more blocks (or networks) were added to or removed from diagram 600.

MENUS can include MIMA 208, Frond End 604, Back Office 602, and External sources 606 connected by APIs. In one aspect, MIMA 208 uses an API based infrastructure platform which contains various modules like Location/Chain management, Zone management, Data processing, Financial, Reporting, Media, Delivery, Order tracking/customer care and internal/external communicate between Supplier and Customer via MENUS. In one example, Front End (Customer Interface) uses mobile/web application which tolls for customer and MIMA connection to filter, find/select, order and receive goods. Back Office (Supplier Interface) is a mobile/web application that tolls for Supplier/MIMA connection to supply, sell and delivery goods.

MENUS, in one embodiment, is relates to the field of communication cloud base networks which consider a complete process of supply, order and delivery of goods (between supplier and customer). For example, MENUS is multi-functional cloud base networking platform to sell any goods and services while has capability to communicate via API with internal User Interfaces and external sources. MENUS communicates with a group of customer and supplier via Mobile/Web user interfaces “UI”. It should be noted that supply, ordering & delivery from a supplier to a customer can be a passive process. Related process and methods can vary by number of parameters like geographic location of customer and supplier, kind of good, method of payment, way to deliver and tolls for communication with supplier & customer. For example, MENUS can be used in an environment of “Restaurants/Chains” as location (“Locations”) and “Food/Menu” (“Menu Item” or “MI”) as merchandise (or good or food) to sell.

Back office, also referred to as supplier interface, includes locations registering in MENUS, getting access to MENUS Back Office to manage location and menu data, receive order directly and some other Function and modules listed as below. Back office, one example, is a tool which an owner of Chain or group of Locations could manage all location in one place in terms of location/Menu Data, Ordering, Coupon and Financial. It could assign access of required user to any locations independently. User level access could be Waiter (staff) and Admin. Service types, pricing, zone management and customer review will happen within this module.

Front End, also referred to as customer interface, is a restful API, MIMA can interface with Mobile application (iOS and Android) WEB application. Front end could be inserted via a widget that gets encapsulated within a http//: or https//: protocol insuring flexibility and ease of use for all data access level. Main key points and steps which consider for ordering a dish by customer include, but not limited to, (1) Find Customer location via GPS or user insert address; (2) Service type could select (default set for Delivery); (3) Select A dish and find Menu item (List view a Map view); (4) Select Menu items; (5) Place order.

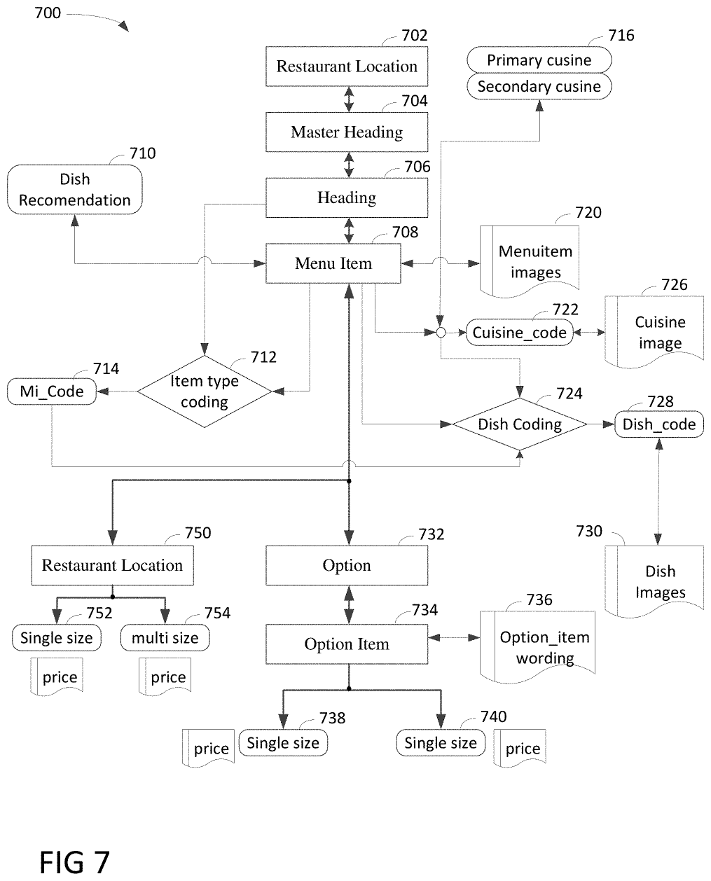

FIG. 7 is a logic flow diagram 700 illustrating a process of menus information flow capable of facilitating food categorization and distribution in accordance with one embodiment of the present invention. Upon identifying restaurant location at block 702, a master heading is obtained at block 704. For example, master heading can be headings between breakfast and lunch. After identifying heading at 706, the process proceeds to block 708 for menu items. Note that headings can be appetizer, entree, and/or dessert. It should be noted that the underlying concept of the exemplary embodiment(s) of the present invention would not change if one or more blocks (or networks) were added to or removed from diagram 700.

At block 714, a MI-code is generated based on item type coding at block 712 which receives input from menu item 708 and heading 706. Menu item 708 receives inputs from heading block 706, dish recommendation 710, and menu item images 720. Menu item 708 provides cuisine code 722 and dish coding 724 wherein cuisine code 722 associates with cuisine images 726. Dish coding 724 is used to facilitate discode 728 and dish images 730. Menu item 708, in one embodiment, provides option 732 and menu items size 750 wherein option 732 can generate option item 734 with single size or multiple size selections 738-740. In one aspect, price tags are associated with size blocks such as blocks 752-754 and 738-740.

Menu process illustrated in flowchart 700 shows a menus information structure which is based on Menu item. Each Menu Item has prices or bulk prices. Menu item has a cuisine type, segment type, day part, availability and service type based on Locations Information an item type based on type of menu item and dish type based on kind of menu item. Food menu item categorization and coding are performed by MENUS wherein the entire Food/Menu items are categorized and processed by machine coding and machine learning.

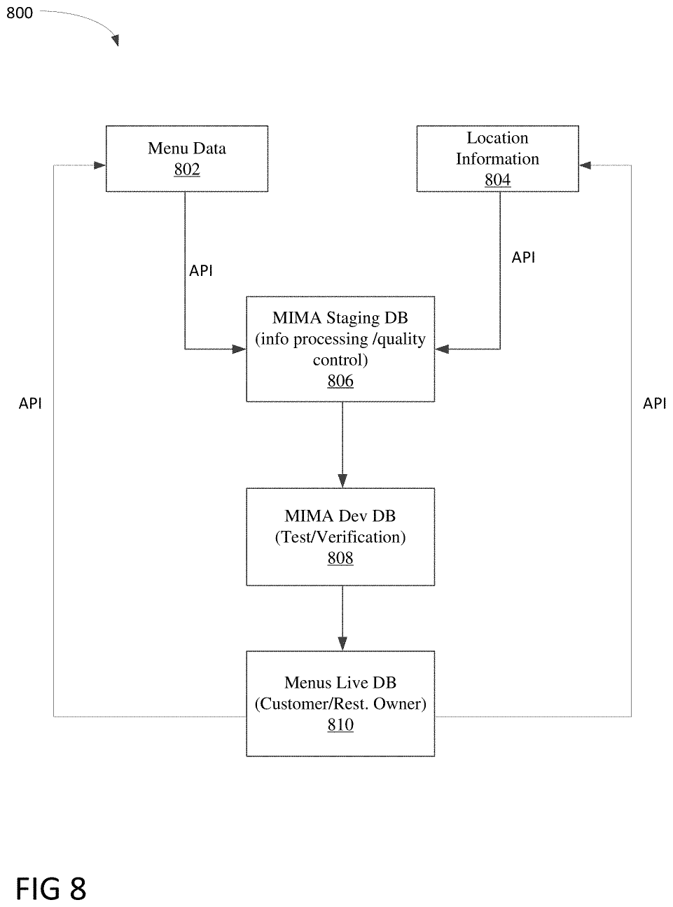

FIG. 8 is a data flow diagram 800 illustrating a logical process of MIMA system used in a restaurant application for providing food ordering and delivery services in accordance with one embodiment of the present invention. Diagram 800 includes an MIMA staging DB 806, menu data 802, location information 804, MIMA development DB block 808, and menus live DB 810. In one aspect, MIMA staging DB 806 receives information or data from menu data 802 and location information 804 via API connections. After the information is processed and quality control is applied, the information is forwarded to MIMA development DB 808 which tests and verifies the information. When the information reaches to Menus live DB, the information such as selections is launched or posted whereby both customer and restaurant can view it. Note that combination of location and menu information of independent restaurants and chain locations involve processing, coding, verifying, and ascertaining quality control on different databases before applying to actual live website. It should be noted that the underlying concept of the exemplary embodiment(s) of the present invention would not change if one or more blocks (or networks) were added to or removed from diagram 800.

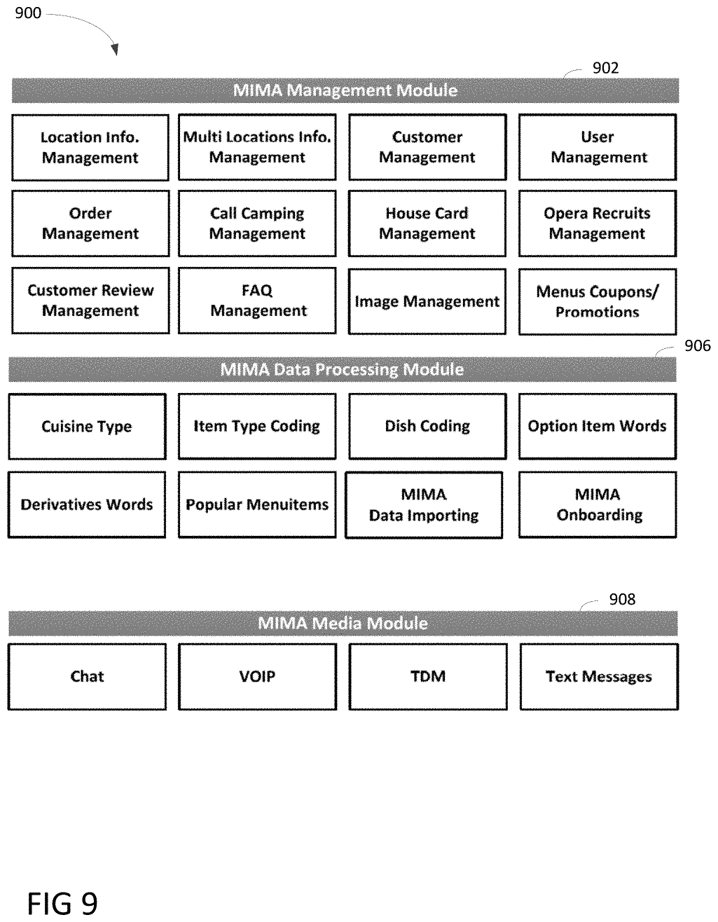

FIG. 9 is a block diagram 900 illustrating functional modules used by MIMA system in accordance with one embodiment of the present invention. Diagram 900 includes MIMA management module 902, MIMA data processing module 906, and MIMA media module 908. MIMA, in one embodiment, is an all-encompassing cloud based modular infrastructure platform for performing at least a portion of MENUS. MIMA platform is built on a restful API interface for multipurpose functions. Main Modules/Functions categories include Security, Management, Data processing, Financial, Reporting, Media, Delivery, Ordering and internal/external Communicate via API.

In one aspect, MIMA management module 902 includes various functional units or circuitry elements, such as, but not limited to, location information management, multi locations information management, customer management, user management, order management, call camping management, house card management, opera recruits management, customer review management, FAQ management, image management, menus coupons, promotions, and the like. MIMA data processing module 906 includes multiple functional units including, but not limited to, cuisine type, item type coding, dish coding, option item words, derivatives words, popular menu items, MIMA data importing, MIMA onboarding, and the like. MIMA media module 908, in one aspect, is responsible for multiple methods of communication, such as, but not limited to, chat, VOIP, TDM, text messages, and the like. It should be noted that the underlying concept of the exemplary embodiment(s) of the present invention would not change if one or more blocks (or functions) were added to or removed from diagram 900.

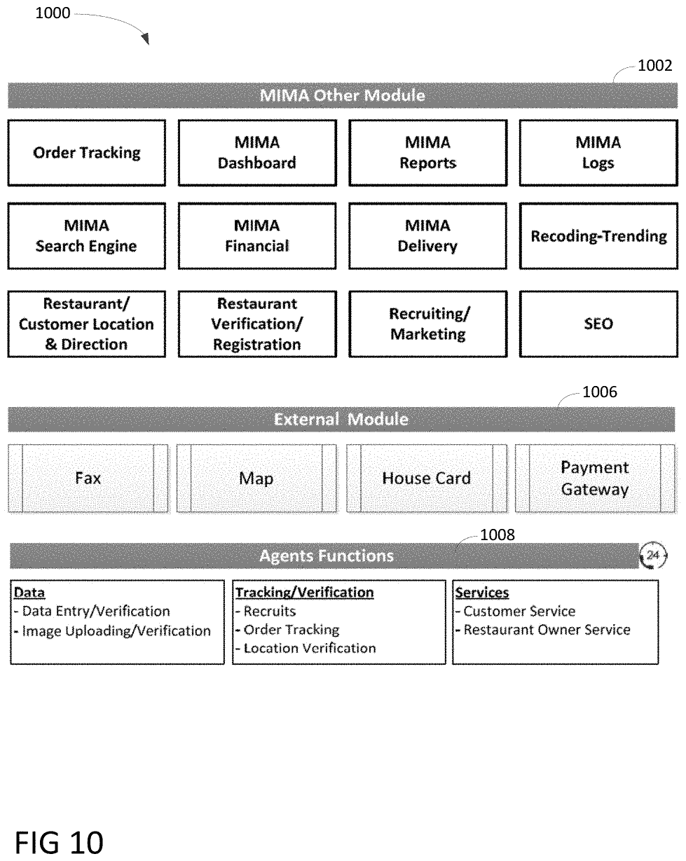

FIG. 10 is a block diagram 1000 illustrating additional modules used by MIMA system in accordance with one embodiment of the present invention. Diagram 1000 includes MIMA other module 1002, external module 1006, and agent's module 1008. In one aspect, MIMA other module 1002 includes various functional units or circuitry elements, such as, but not limited to, order tracking, MIMA dashboard, MIMA reports, MIMA logs, MIMA search engine, MIMA financial, MIMA delivery, recording-trending unit, restaurant location/direction, verification/registration, recruiting/marketing, SEO (search engine optimization), and the like. External module 1006 includes multiple functional units including, but not limited to, fax, map, house card, payment gateway, and the like. Agents functions 1008, in one aspect, includes data collector, tracking/verification, and services and is responsible for multiple methods of facilitate agents' data and service management. For example, data collector facilitates data entry/verification as well as image uploading and verification. The tracking/verification element may be responsible for recruiting, order tracking, and location verification. The service unit, in one embodiment, relates to customer service as well as restaurant owner services. It should be noted that the underlying concept of the exemplary embodiment(s) of the present invention would not change if one or more blocks (or functions) were added to or removed from diagram 1000.

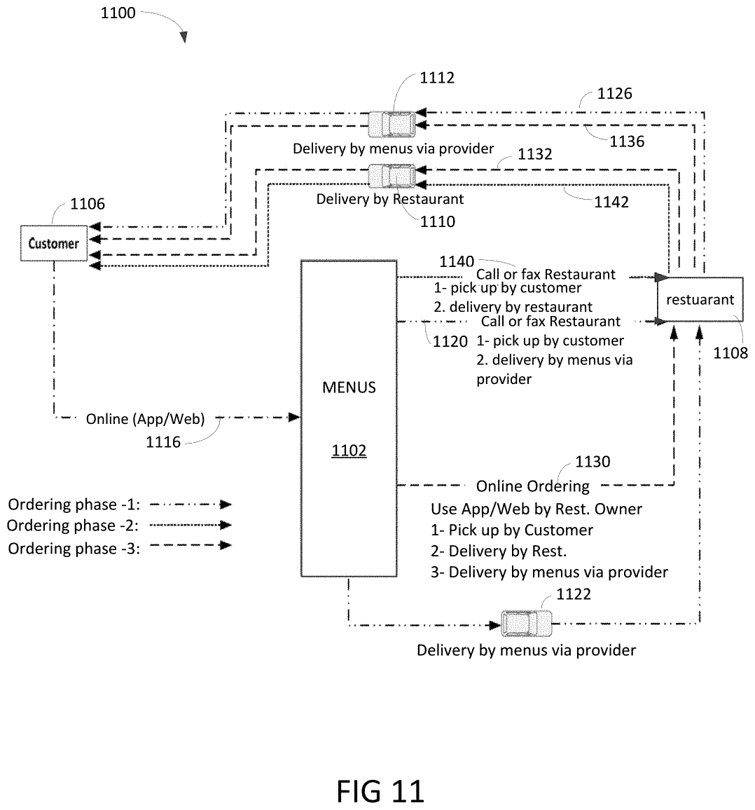

FIG. 11 is a logic block diagram 1100 illustrating an ordering and delivery process facilitated by Menus within the MIMA system in accordance with one embodiment of the present invention. Diagram 1100 includes a customer or user 1106, Menus 1102, and restaurant 1108 showing a process of food ordering and delivery. In one aspect, the delivery system includes delivery by restaurant 1110 or delivery by provider 1112. It should be noted that the underlying concept of the exemplary embodiment(s) of the present invention would not change if one or more blocks (or networks) were added to or removed from diagram 1100.

Menus 1102, in one embodiment, provides two primary method of delivery system in which the first delivery system is food delivery by location owner while the second delivery system is delivery food by third party or delivery provider also referred to as delivery by Menus. Delivery by MENUS, in one example, is to deliver food by a delivery company partner. MENUS can use multiple delivery company. In one example, the delivery service selection is based on the variety of dynamic variables set within MIMA based on data received from each delivery company such as price per mile, minimal order fee, estimated time or arrival, number of left and right turns made between delivery, and pickup location. Delivery request, cancellation, and feedback (Confirmation, delivery notices & cancellation) are quickly communicated to third party delivery partners via API connections.

Depending on the modules selected of MIMA, an administrator could enable MIMA to work as a standalone platform without the HTTP or HTTPS external posting (SEO) for internal or external (marketplace) online ordering managed by MENUS or Location Owner. Menus, in one example, offers the two types of subscriptions to restaurant owner and/or restaurant chains. The first type of subscription is restaurant managed by MENUS, such as fee arrangement and delivery method. For example, while subscription may be free, customer service charge applies with restaurant delivery. The second type subscription is that while it is free, the delivery by third party partner is used. In one aspect, delivery by restaurant, the restaurant owners may have the capability to waive a percentage of delivery charge based on the dynamic parameters which, for example, may offset some of the cost based on distance and the orders.

In one embodiment, MENUS Platform is a media for Restaurant owner to manage one to multi location via MENUS cloud base system. Menus allows users or vendors to customize mobile/Web applications and POS system. Depend on location subscription and delivery method, Menus is able to execute ordering phases depending on the applications, user, and restaurant(s). For example, ordering phase-1 includes ordering by menus via call or fax to restaurant & delivery by MENUS via provider. After a customer orders online, a payment option such as customer payment online to restaurant via restaurant's “House Card” or other electronic payment means. The option for the food delivery can either be pickup, delivery by restaurant or third-party delivery.

In operation, when customer 1106 places an online order 1116 via App, menus 1102 places an order 1120 at restaurant POS after authentication using various authentication parameters including customer's phone number. Order 1120 can either be placed by a call or fax indicating whether the food will be picked up by customer or delivered by menus via provider 1122. After receiving and prepared the order, restaurant 1108 delivers the food to customer 1106 via delivery channel 1126. Alternatively, order 1130 can be placed via user App to the website of restaurant indicating the food will be either picked up or delivered by either restaurant or menus. After receiving and prepared the order, restaurant 1108 delivers the food to customer 1106 via delivery channels 1132 or 1136 depending on the who delivers. Order 1140 can either be placed by a call or fax indicating whether the food will be picked up by customer or delivered by restaurant. After receiving and prepared the order, restaurant 1108 delivers the food to customer 1106 via delivery channel 1142.

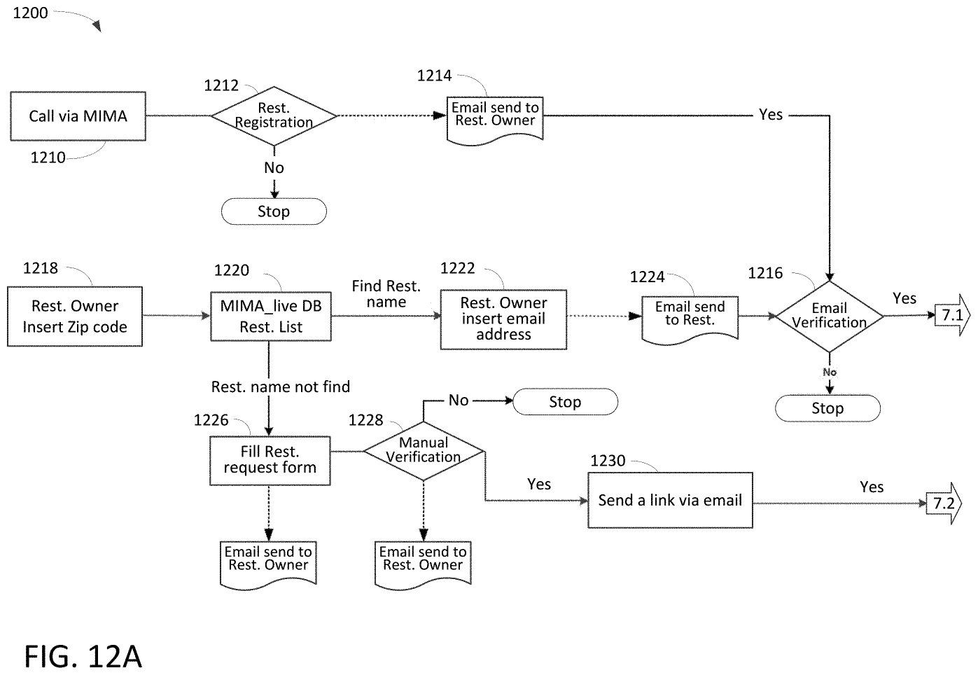

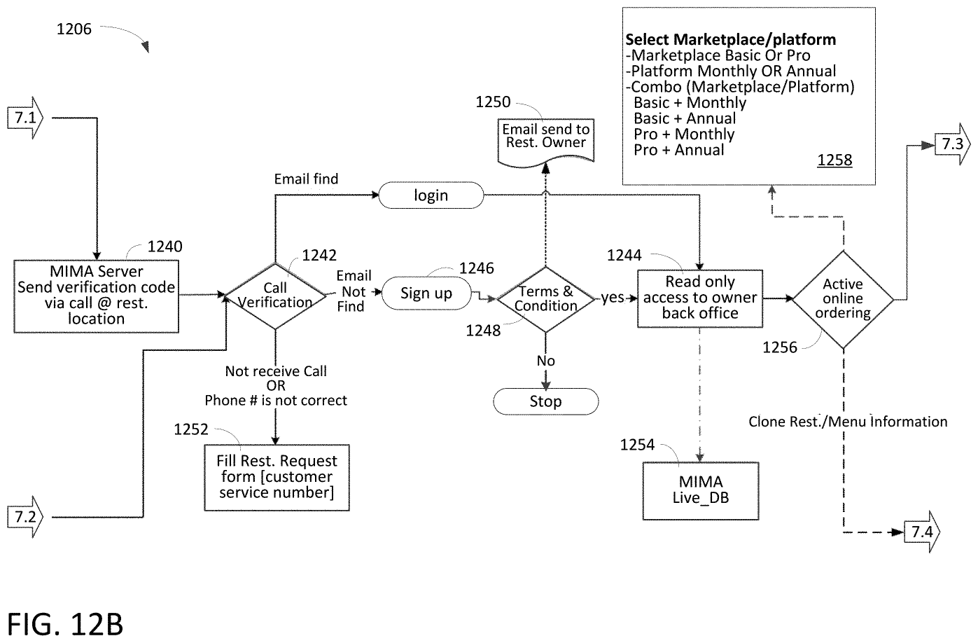

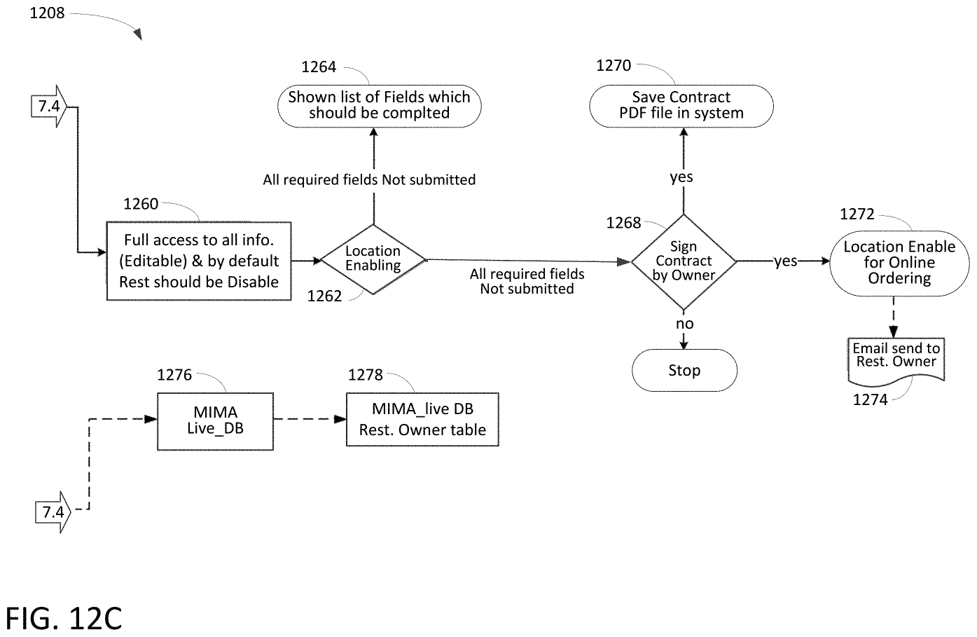

FIGS. 12A-12C are a set of flow diagrams 1200-1208 illustrating a process of restaurant registration and verification operated by the MIMA system in accordance with one embodiment of the present invention. Diagrams 1200-1208 illustrate a unique function of MENUS which is capable of self-servicing for registration/verification using MENUS via the Internet. It should be noted that as long as the information is imported via different modes such as SQL replication, ASCII file importing, native API, or the like, any Location could sign up for free for using MENUS to get access to the Location/Menus information with the categorization and MenuSense™. For example, location or restaurant could register for online ordering as basic or pro (market place) membership to enable Menus' functionalities without SEO or HTTP or HTTPS functionalities. Menus also provide a function of e-signing for subscriptions and/or contracts. In one aspect, the important information relating to the registration and payments can be stored into block chain for reliability and ease of access.

In case a Location is not able to find its record set in the MENUS database, fail-safe measure is put in place by displaying a generic form to the user and forwarding it to an agent via various form of communication (VOIP, TDM, EMAIL or AUTO ring functionality within the system for a menus agent to assist the registration as a new customer. For example, Menus or MIMA system provides a default in which it is set to transfer calls internally via VOIP to the next available agent utilizing Asterix open source technology. Because of if modular development, this process could be easily changed to accommodate the desired work flow requirements. It should be noted that the underlying concept of the exemplary embodiment(s) of the present invention would not change if one or more blocks (or networks) were added to or removed from diagrams 1200-1208.

Flow diagram 1200 illustrates a process of verifying restaurant email whether the registration is initiated by MIMA at block 1210 or restaurant owner 1218. At block 1210, MIMA calls, checks, and obtains a restaurant registration at block 1212. If the restaurant information is found, the process proceeds to block 1214. At block 1214, an email is sent to restaurant owner and then proceeds to block 1216. At block 1218, the process receives a zip code entered by the restaurant owner and proceeds to block 1220 to exam restaurant list stored in MIMA live DB. If the restaurant name is found the process proceeds to block 1222, otherwise the process proceeds to block 1226. At block 1222, the process inserts or records email address supplied by restaurant owner and proceeds to send an email to restaurant owner at block 1224. At block 1216, at verifying the email, the process proceeds to diagram 12B following numeral 7.1. At block 1226, a restaurant request form is filled and the completed restaurant request form is emailed to the restaurant owner. After manually verified request form at block 1228, the process proceeds to send a link via email at block 1230.

Flow diagram 1206 illustrates a continuing process of flow diagram 1200 in which it verifies an order using MIMA system in accordance with one embodiment of the present invention. When MIMA server receives a call at block 1240, the call verification begins at block 1242. When an email associated with the call is found at block 1242, the process proceeds to access owner back office at block 1244 after login process. When the email associated with the call is not found at block 1242, the process proceeds to post terms & conditions at block 1248 after requesting for signing up at block 1246. After acknowledging the terms & conditions, an email is sent to restaurant owner at block 1250 while accessing owner back office at block 1244. access owner back office at block 1244. At block 1252, a restaurant request form is filled if the call is not received or the phone number does not match with stored number. After accessing and/or updating the MIMA live-DB at block 1254, the process proceeds to activate online ordering at block 1256. MIMA provides and selects marketplace and platform at block 1258 before proceeds to the next.

Flow diagram 1208 illustrates the continuing process of flow diagram 1206. The process at block 1260 makes full accessible to restaurant information and proceeds to block 1262 for enabling location. If all required fields are not submitted, the process shows missing fields at block 1264. If all required fields are submitted, the process exams signed contract at 1268. If the contract is signed, the contract is saved in PDF file and proceeds to block 1272 for location enabling for online ordering. The restaurant owner is emailed to notifying online activation at block 1274. Note that MIMA live DB at block 1276 is activated and accessible include restaurant's table in block 1278.

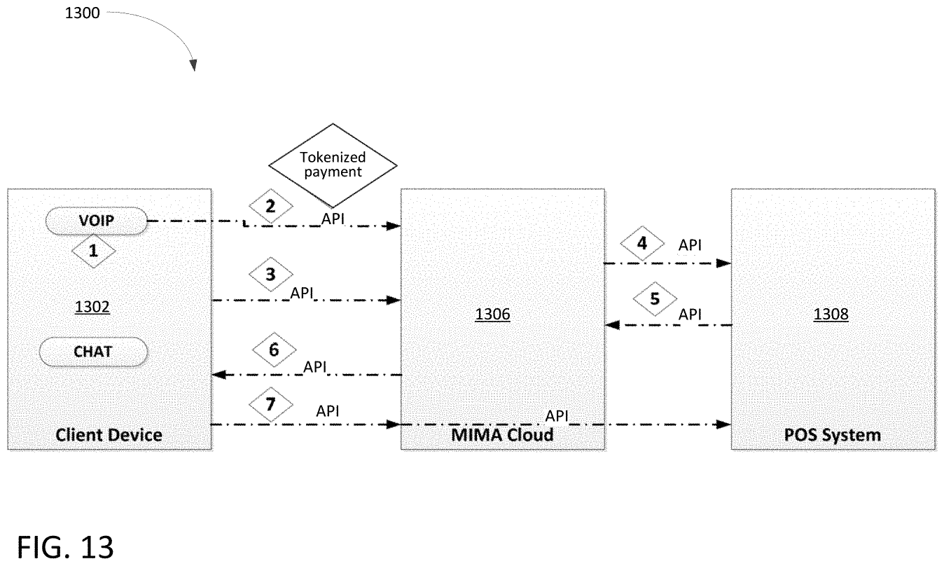

FIG. 13 is a block diagram 1300 illustrating a payment process facilitated by the MIMA system in accordance with one embodiment of the present invention. Diagram 1300 includes a client device 1302, MIMA cloud 1306, and POS system 1308 wherein client device 1302 can be a UE or customer and POS system 1308 resides at vendor block. It should be noted that the underlying concept of the exemplary embodiment(s) of the present invention would not change if one or more blocks (or networks) were added to or removed from diagram 1300.

At step 1 as indicated by numeral 1, a VOIP client is in capsulated by a client device 1302 which can be in any form that allows VOIP connection. Client device 1302 has a direct chat connection to MIMA cloud 1306 which can be enabled under the MIMA management platform that enables the VOIP gateway for communication via client device 1302.

At step 2 as indicated by numeral 2, upon activating this feature the system engages the communication protocol with a payment gateway creating a secure socket layer and payment tokenization outside MIMA cloud 1306 for additional security purposes.

At step 3 as indicated by numeral 3, the VOIP signaling is paired with the metadata from client device 1303 and is passed to MIMA Cloud 1306 restful API.

At step 4 as indicated by numeral 4, a signaling session is passed through the VOIP interface within MIMA cloud 1306 to either another VOIP connection to POS system 1308 or through a regular TDM signaling. MIMA Cloud Restful API passes the tokenized payment information and required client metadata to POS system 1308. At this point POS system 1308 and client device 1306 are connected through either VOIP to VOIP networking inside MIMA cloud or VOIP to TDM signaling.

At step 5 as indicated by numeral 5, POS system 1308 selects the requested menu items and option modifiers within the system. Upon pressing confirmation button, the POS system 1308 passes back the Tokenized payment key and relevant meta data back to MIMA restful API.

At step 6 as indicated by numeral 6, the payment processing module gets activated within the system using the chat client on the mobile device. The metadata on POS system 1308 is now residing on client device 1302 through the connection of MIMA server 1306 and the CHAT hook client. An advantage of using this payment process is that the customer can process the payment without stating its location or payment information over the phone for security and confidentiality purposes if required. In one aspect, this system is also capable to auto calculate the distance between the two nodes pickup and delivery based on the rate table, delivery flat rate and time of day when it applies

At step 7 as indicated by numeral 7, upon successful settlement and approval of the payment a settlement approval is communicated via MIMA restful API server and POS and all required additional modules (i.e. preparation, dispatching) could be activated for work flow processing i.e. delivery by restaurant or delivery company.

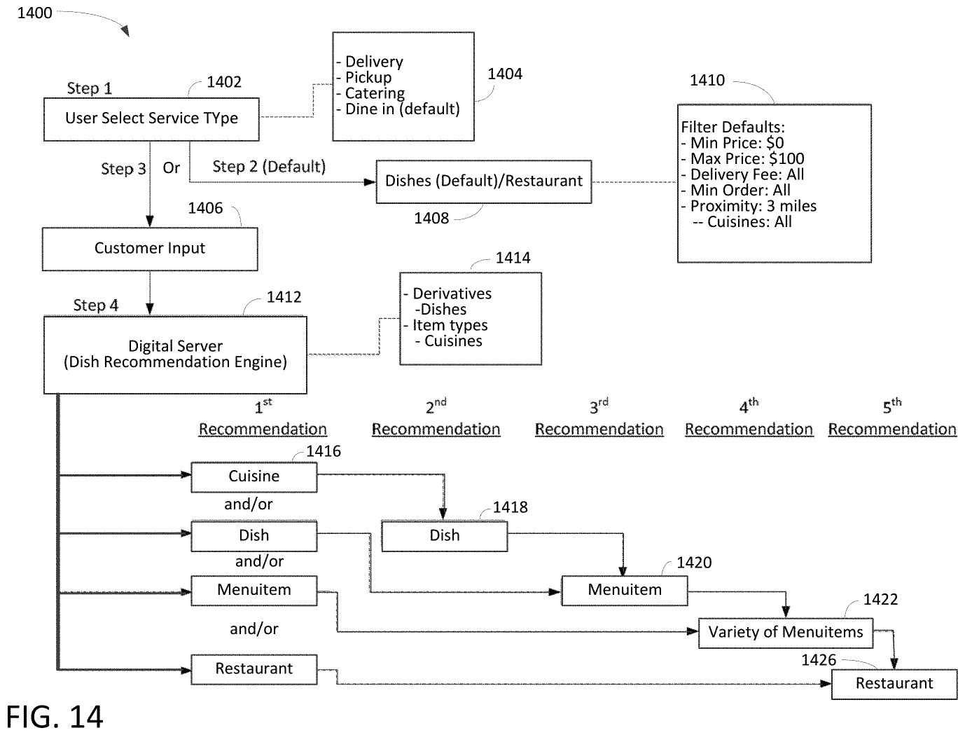

FIG. 14 is a logic flow diagram 1400 illustrating a process of providing recommendations or alternatives facilitated by the MIMA system in accordance with one embodiment of the present invention. The process, at block 1402, allows a user to select a service type based on selection list 1404. After selection, user selects a dish or dishes at block 1408 based on filter defaults 1410. Upon receiving customer input at block 1406, the process at block 1412 provides dish recommendation based on a predefined list 1414. Upon recommending a cuisine at block 1416, a dish is referred at block 1418. Once a menu item is selected at block 1420, variety of menu items may be recommended at block 1422. The recommendation process ends when a restaurant 1426 is selected. It should be noted that the underlying concept of the exemplary embodiment(s) of the present invention would not change if one or more blocks (or steps) were added to or removed from diagram 1400.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

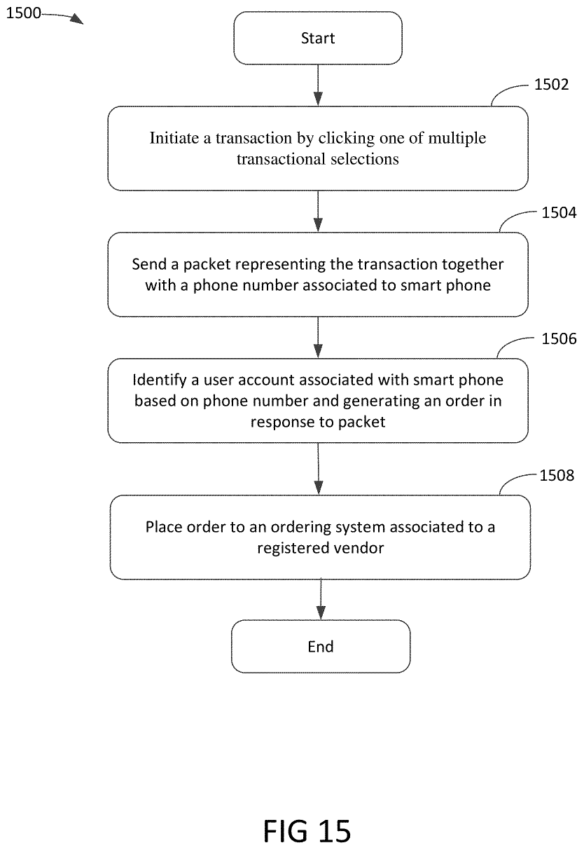

FIG. 15 is a flow chart 1500 illustrating a process of facilitating a real-time e-commerce in accordance with one embodiment of the present invention. At block 1502, a process operable by the MIMA system coupled to a cloud networking such as the UCC platform through wireless connections via a smart phone initiates a transaction by clicking one of multiple transactional selections managed by a mobile application displayed on a screen of a smart phone. In one aspect, after browsing displayed selections facilitated by the app, a displayed selection is touched or pushed on the screen of the smart phone. In one example, the process is capable of launching a food order by clicking a dish icon displayed on the screen of a smart phone. Alternatively, a travel package can be launched by clicking a trip icon displayed on the screen of a smart phone. In one embodiment, the app is able to provide an alternative option with similar goods with different prices. For example, when a customer wants to order a coffee, the app supported by the MIMA system can push a coupon with different coffer shop to the customer before the customer places the order.

At block 1504, a packet representing the transaction together with a phone number associated to the smart phone is sent from the smart phone to an app server via a first communication network. In one embodiment, after identifying the geographic location of the smart phone when the transaction is initiated, the geographic location is inserted into the packet.

At block 1506, a user account associated with the smart phone is identified based on the phone number and generating an order in response to the packet and retrieved information from the user account. For example, after searching the user account through a local storage device containing a plurality of accounts in response to the phone number, the user's identifier (“ID”), user's preference, user's default address, and user's payment preferences is obtained or retrieved. from the user account. The process is also capable of composing the order to including payment information and the phone number.

At block 1508, the order is placed from the app server to an ordering system associated to a registered vendor via a second communication network for facilitating the transaction. For example, the process is able to queue the order to an order processing queue of a point of sale (“POS”) system physically located at a restaurant via a network channel. In one embodiment, the process is capable of providing an alternative transactional option based on a user's inquiry and a price comparison within a geographic area based on a user's inquiry. The process can also provide a vendor comparison within a geographic area based on a user's inquiry. A vendor report containing search frequency, missing items, and price analysis can be generated in accordance with a predefined period of time. Note that the vendor report includes item suggestions and demographic updates. For example, a user report contains item suggestions, selection habit, and demographic updates.

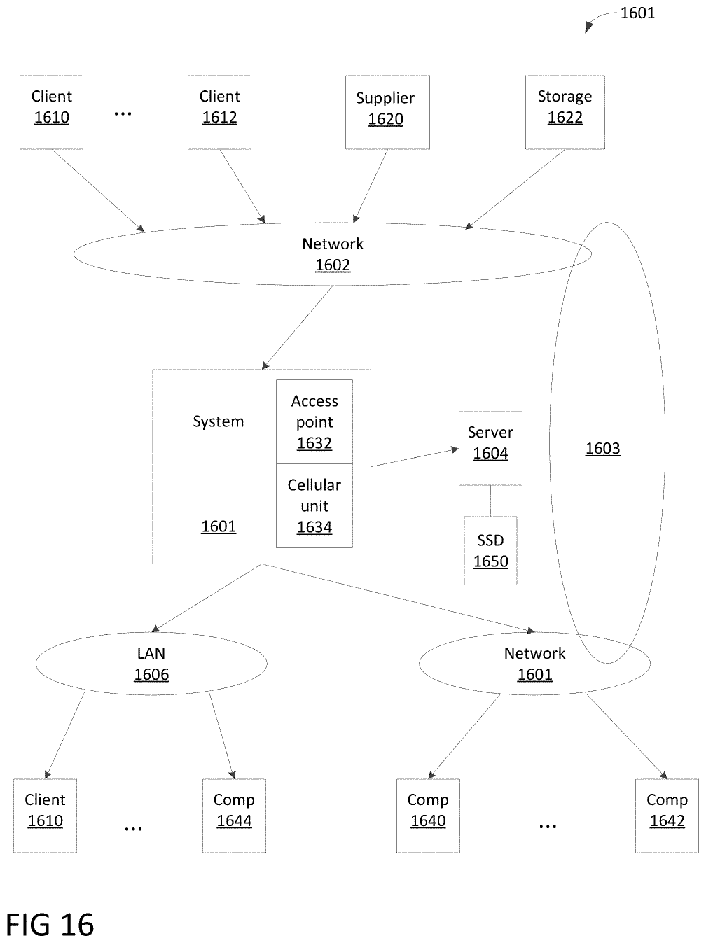

FIG. 16 is a diagram 1600 illustrating a computer network capable of facilitating UCC platform in accordance with one embodiment of the present invention. In this network environment, a system 1601 is coupled to a wide-area network 1602, LAN 1606, system 1601, and server 1604. Wide-area network 1602 includes the Internet, or other proprietary networks including America On-Line™, SBC™, Microsoft Network™, and Prodigy™. Wide-area network 1602 may further include network backbones, long-haul telephone lines, Internet service providers, various levels of network routers, and other means for routing data between computers.

Server 1604 is coupled to wide-area network 1602 and is, in one aspect, used to route data to clients 1610-1612 through a local-area network (“LAN”) 1606. Server 1604 is coupled to storage device 1650 to enhance overall memory efficiency and e-commerce.

The LAN connection allows client systems such as client 1610 to communicate with each other through LAN 1606. Using conventional network protocols, the system may communicate through wide-area network 1602 to client computer systems 1610-1612, supplier system 1620 and storage device 1650. For example, client system 1610 is connected directly to wide-area network 1602 through direct or dial-up telephone or other network transmission lines. Alternatively, clients 1610-1612 may be connected through wide-area network 1602 using a modem.

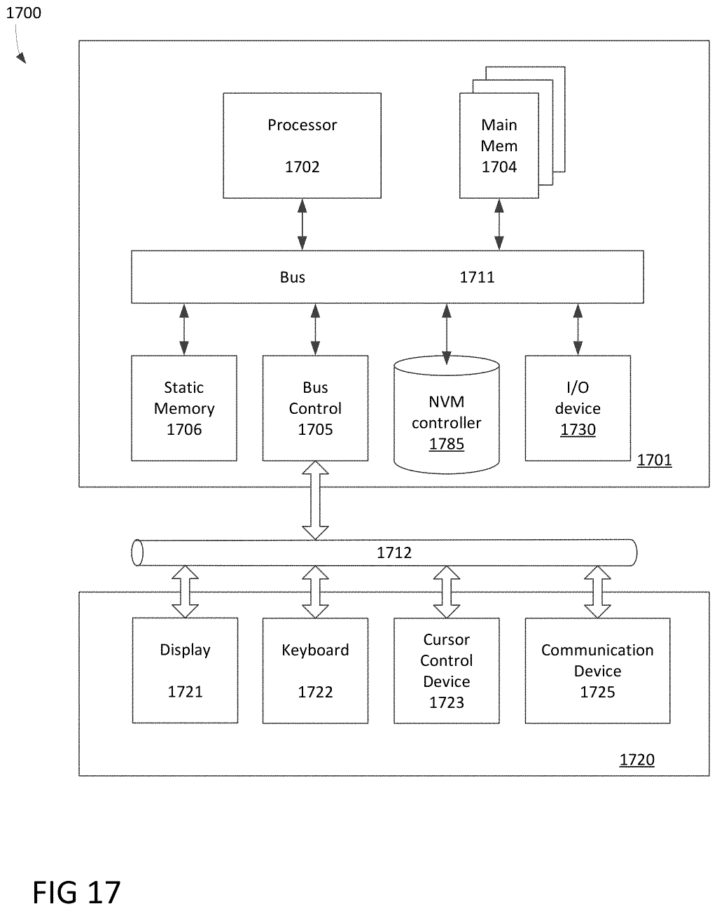

Having briefly described one embodiment of the computer network in which the embodiment(s) of the present invention operates, FIG. 17 illustrates an example of a computer system 1700, which can be a machine capable of providing e-commerce including food ordering and delivery.

FIG. 17 is a block diagram illustrating a digital processing system 1700 capable of being used and/or implementing the MIMA system and/or various modules for food related e-commerce in accordance with one embodiment of the present invention. Computer system or a signal separation system 1700 includes a processing unit 1701, an interface bus 1712, and an input/output (“TO”) unit 1720. Processing unit 1701 includes a processor 1702, a main memory 1704, a system bus 1711, a static memory device 1706, a bus control unit 1705, an I/O element 1730, and an NVM controller 1785. It should be noted that the underlying concept of the exemplary embodiment(s) of the present invention would not change if one or more blocks (circuit or elements) were added to or removed from FIG. 17.

Bus 1711 is used to transmit information between various components and processor 1702 for data processing. Processor 1702 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 1704, which may include multiple levels of cache memories, stores frequently used data and instructions. Main memory 1704 may be RAM (random access memory), MRAM (magnetic RAM), or flash memory. Static memory 1706 may be a ROM (read-only memory), which is coupled to bus 1711, for storing static information and/or instructions. Bus control unit 1705 is coupled to buses 1711-1712 and controls which component, such as main memory 1704 or processor 1702, can use the bus. Bus control unit 1705 manages the communications between bus 1711 and bus 1712. Mass storage memory or SSD 1706, which may be a magnetic disk, an optical disk, hard disk drive, floppy disk, CD-ROM, and/or flash memories are used for storing large amounts of data.

I/O unit 1720, in one embodiment, includes a display 1721, keyboard 1722, cursor control device 1723, and communication device 1725. Display device 1721 may be a liquid crystal device, cathode ray tube (“CRT”), touch-screen display, or other suitable display device. Display 1721 projects or displays images of a graphical planning board. Keyboard 1722 may be a conventional alphanumeric input device for communicating information between computer system 1700 and computer operator(s). Another type of user input device is cursor control device 1723, such as a conventional mouse, touch mouse, trackball, or other type of cursor for communicating information between system 1700 and user(s).

Communication device 1725 is coupled to bus 1711 for accessing information from remote computers or servers, such as server 1704 or other computers, through wide-area network 1602. Communication device 1725 may include a modem or a network interface device, or other similar devices that facilitate communication between computer 1700 and the network. Computer system 1700 may be coupled to a number of servers 1704 via a network infrastructure such as the infrastructure illustrated in FIG. 16.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method, operable by a smart phone coupled to a cloud networking through wireless connections, for facilitating web-based e-commerce transaction between two remote users connected via a communication network, comprising:
initiating a transaction by clicking one of multiple transactional selections managed by a mobile application (“app”) displayed on a screen of a smart phone;
sending a packet representing the transaction together with a phone number associated to the smart phone from the smart phone to an app server via a first communication network;
identifying a user account associated with the smart phone based on the phone number and generating an order in response to the packet and information retrieved from the user account; and
placing the order from the app server to an ordering system associated to a registered vendor via a second communication network for facilitating the transaction.

2. The method of claim 1, further comprising providing an alternative transactional option based on a user's inquiry.

3. The method of claim 1, further comprising providing a price comparison within a geographic area based on a user's inquiry.

4. The method of claim 1, further comprising providing a vendor comparison within a geographic area based on a user's inquiry.

5. The method of claim 1, further comprising generating a vendor report containing search frequency, missing items, and price analysis in accordance with a predefined period of time.

6. The method of claim 5, wherein the vendor report includes item suggestions and demographic updates.

7. The method of claim 1, further comprising generating a user report containing item suggestions, selection habit, and demographic updates.

8. The method of claim 1, wherein initiating a transaction includes:
browsing displayed selections facilitated by the app; and
touching a displayed selection on the screen of the smart phone.

9. The method of claim 1, wherein initiating a transaction includes launching a food order by clicking a dish icon displayed on the screen of a smart phone.

10. The method of claim 1, wherein initiating a transaction includes launching a travel package by clicking a trip icon displayed on the screen of a smart phone.

11. The method of claim 1, wherein sending a packet representing the transaction includes
identifying a geographic location of the smart phone when the transaction is initiated; and
inserting the geographic location into the packet.

12. The method of claim 1, wherein identifying a user account associated with the smart phone based on the phone number includes:
searching the user account through a local storage device containing a plurality of accounts in response to the phone number; and
obtaining user's identifier (“ID”), user's preference, user's default address, and user's payment preferences from the user account.

13. The method of claim 1, wherein generating an order in response to the packet includes composing the order to including payment information and the phone number.

14. The method of claim 1, wherein placing the order includes queuing the order to an order processing queue of a point of sale (“POS”) system physically located at a restaurant via a network channel.

15. A method of menu information management administration (“MIMA”), operable by a unified cloud-based computing (“UCC”) platform coupled to a cloud networking, for facilitating web-based e-commerce transactions between users, the method comprising:
identifying and obtaining an online menu posted by a restaurant for offering a list of food selections;
recording a geographic location of the restaurant and name of the restaurant;
parsing the online menu in accordance with headings to differentiate dinner selections from lunch selections;
determining whether a first menu item listed under dinner selections has a menu item code (“MI_code”) or a dish code based on a set of predefined categorizing rules, wherein the MI_code categorizes at least a portion of the dish code; and
storing the geographic location, the name, Mi-code, and cuisine image in a local storage memory.

16. The method of claim 15, further comprising:
extracting menu-item size, price, and option item(s) from the first menu item based on a self-learning module for recognizing size option and price listed on a menu; and
storing the menu-item size, price, and option item(s) in the local storage memory.

17. The method of claim 15, further comprising:
determining whether a second menu item listed under dinner selections is a menu item code (“MI_code”) or a dish code based on the set of predefined categorizing rules; and
storing MI_code and cuisine image in the local storage memory.

18. A unified cloud-based computing (“UCC”) platform containing menu information management administration (“MIMA”) for facilitating web-based commercial transactions between customers and vendors, the UCC platform comprising:
a plurality of vendors coupled and registered with the UCC platform for offering goods and services in accordance with their online menus posted via their own websites;
a plurality of customers coupled and registered with the UCC platform and able to view various advertisements on their smart phones via a UCC application (“App”); and
an MIMA module coupled to the UCC platform and configured to continuously update MIMA vendor database (“DB”) via an online self-learning monitoring device, wherein the MIMA module is able to provide an alternative option based on information stored in MIMA DB when a customer is in a process of placing an order.

19. The system of claim 18, wherein the plurality of vendors is a group of restaurants.

20. The system of claim 18, wherein the MIMA module is able to generate a real-time market competitive report to a restaurant subscriber.
